(19) United States
(12) Patent Application Publication
(10) Pub. No.: US 2011/0193982 A1
(43) Pub. Date: Aug. 11, 2011

(54) METHOD AND APPARATUS FOR PROCESSING AND REPRODUCING CAMERA VIDEO

(75) Inventors: Seung-ryong Kook, Suwon-si (KR); Yun-sun Baek, Suwon-si (KR); Jae-sung Park, Gunpo-si (KR)

(73) Assignee: SAMSUNG ELECTRONICS CO., LTD., Suwon-si (KR)

(21) Appl. No.: 13/004,100

(22) Filed: Jan. 11, 2011

(30) Foreign Application Priority Data
Feb. 5, 2010 (KR) 10-2010-0011188

(51) Int. Cl. H04N 5/228

(52) U.S. Cl. 348/222.1; 348/E05.031

(57) ABSTRACT

A camera video processing/producing method and apparatus is provided. In the camera video processing method, an aspect ratio of a captured image is determined, and a horizontal/vertical image is rotated according to the display orientation of a preview screen of a camera according to the determination result. The rotation information of the horizontal/vertical image is set in a codec parameter, and the codec parameter and the image are encoded.

### CROSS-REFERENCE TO RELATED PATENT APPLICATION

This application claims the benefit of Korean Patent Application No. 10-2010-0011188, filed on Feb. 5, 2010, in the Korean Intellectual Property Office, the disclosure of which is incorporated herein in its entirety by reference.

### BACKGROUND

1. Field

The exemplary embodiments relate to mobile devices, and more particularly, to a method and apparatus for processing and producing camera video in a mobile device.

2. Description of the Related Art

Mobile devices provide various additional functions such as a voice call function, a wireless Internet service function, and a camera function. A mobile device with a camera function has a camera module for photographing a subject, thus enabling a user to photograph and store a desired image anytime, anywhere.

In general, if a mobile device captures an image horizontally or vertically, a television (TV) displays the horizontal or vertical image in a different aspect ratio (i.e., a different horizontal-to-vertical ratio).

For example, if a horizontal image captured by a mobile device is displayed on a TV or a personal computer (PC), the TV or the PC may correctly display the horizontal image horizontally. However, if a vertical image captured by the mobile device is displayed on a TV or a PC, the TV or the PC incorrectly displays the vertical image horizontally, i.e., displays the vertical image on its side, because the TV or the PC does not recognize that the image is a vertical image.

Thus, an image must be rotated in the TV or the PC because the TV or the PC is unable to determine whether the mobile device captured the image horizontally or vertically.

### SUMMARY

The exemplary embodiments provide a camera video processing/producing method and apparatus for efficiently communicating camera video between a mobile device and a video reproducing apparatus even without correcting a video format.

According to an aspect of an exemplary embodiment, there is provided a camera video processing method including: determining an aspect ratio of a captured image; rotating a horizontal/vertical image according to the display orientation of a preview screen of a camera according to the determination result; setting the rotation information of the horizontal/vertical image in a codec parameter; and encoding the codec parameter and the image.

The determining of the aspect ratio may detect camera gravity direction information by a gravity sensor and determines the aspect ratio on the basis of the detected camera gravity direction information.

The rotating of the horizontal/vertical image may rotate a moving/still image by a predetermined angle if the moving/still image is a vertical image.

The setting of the codec parameter may set updated horizontal/vertical image information to codec parameter information whenever the camera gravity direction changes during a video photographing operation.

The codec parameter information may include the size and ratio of the horizontal/vertical image at the time when the camera gravity direction changes during the video photographing operation.

The codec parameter information may be added whenever the camera gravity direction information changes during the video photographing operation.

The setting of the codec parameter may correct information related to the pixel of a horizontal/vertical image of a moving/still image.

The camera video processing method may further include formatting the encoded codec parameter and image data into a bitstream of a predetermined standard.

According to another aspect of an exemplary embodiment, there is provided a camera video reproducing method including: receiving a camera image bitstream; extracting image data and codec parameter information from the camera image bitstream; extracting horizontal/vertical image information from the codec parameter information; and rescaling the size of a vertical image according to the height of a display screen on the basis of the horizontal/vertical image information.

According to another aspect of an exemplary embodiment, there is provided a camera video processing apparatus including: an aspect ratio determining unit for determining an aspect ratio of a captured image by using gravity sensor information; an image rotating unit for rotating a horizontal/vertical image according to the display orientation of a preview screen of a camera according to the determination result of the aspect ratio determining unit; a codec parameter setting unit for adding the rotation information of the horizontal/vertical image, received from the image rotating unit, in a codec parameter; and an encoder for encoding the image and the codec parameter of the codec parameter setting unit.

In another aspect of an exemplary embodiment, there is provided a camera video processing method including: determining an aspect ratio of a captured image; rotating the captured image according to a display orientation of a preview screen of an image capture device according to the determined aspect ratio, to output a rotated image and rotation information; setting the rotation information of the captured image in a codec parameter; and encoding the codec parameter and the rotated image.

In yet another aspect of an exemplary embodiment, there is provided a camera video reproducing method including: receiving a camera image bitstream; extracting image data and codec parameter information from the camera image bitstream; extracting horizontal image information or vertical image information from the codec parameter information; and rescaling a size of a vertical image according to a height of a display screen based on the horizontal or the vertical image information.

In another aspect of an exemplary embodiment, there is provided a camera video processing apparatus including: an aspect ratio determining unit which determines an aspect ratio of a captured image by using gravity sensor information; an image rotating unit which rotates a horizontal image or a vertical image according to a display orientation of a preview screen of an image capture device according to a determination result of the aspect ratio determining unit, to output a rotated image and rotation information; a codec parameter setting unit which adds the rotation information of the rotated image, received from the image rotating unit, in a codec parameter; and an encoder which encodes the rotated image and the codec parameter of the codec parameter setting unit.

### BRIEF DESCRIPTION OF THE DRAWINGS

The above and other features will become more apparent by describing in detail exemplary embodiments thereof with reference to the attached drawings in which:

FIG. 1 is a conceptual diagram illustrating the communication of camera video between a camera video processing apparatus and a camera video reproducing apparatus, according to an exemplary embodiment;

FIG. 2 is a block diagram of the camera video processing apparatus according to an exemplary embodiment;

FIG. 3 is a block diagram of an image processor of FIG. 2, according to an exemplary embodiment;

FIG. 4 is a flowchart illustrating a camera video processing method according to an exemplary embodiment;

FIG. 5 is a flowchart illustrating an image aspect ratio determining operation of FIG. 4, according to an exemplary embodiment;

FIG. 6 is a flowchart illustrating a codec parameter setting operation of FIG. 4, according to an exemplary embodiment;

FIG. 7 is a flowchart illustrating a camera video reproducing method according to an exemplary embodiment;

FIGS. 8A to 8C are conceptual diagrams illustrating the construction of a bitstream in a video photographing operation, according to exemplary embodiments; and

FIGS. 9A and 9B illustrate a rendering method of a camera video reproducing apparatus, according to exemplary embodiments.

### DETAILED DESCRIPTION

The exemplary embodiments will now be described more fully with reference to the accompanying drawings.

Before describing the configuration of a camera video processing/producing apparatus according to an exemplary embodiment, a description is given of an approach to efficiently communicate camera video between a camera video processing apparatus and a camera video reproducing apparatus according to an exemplary embodiment.

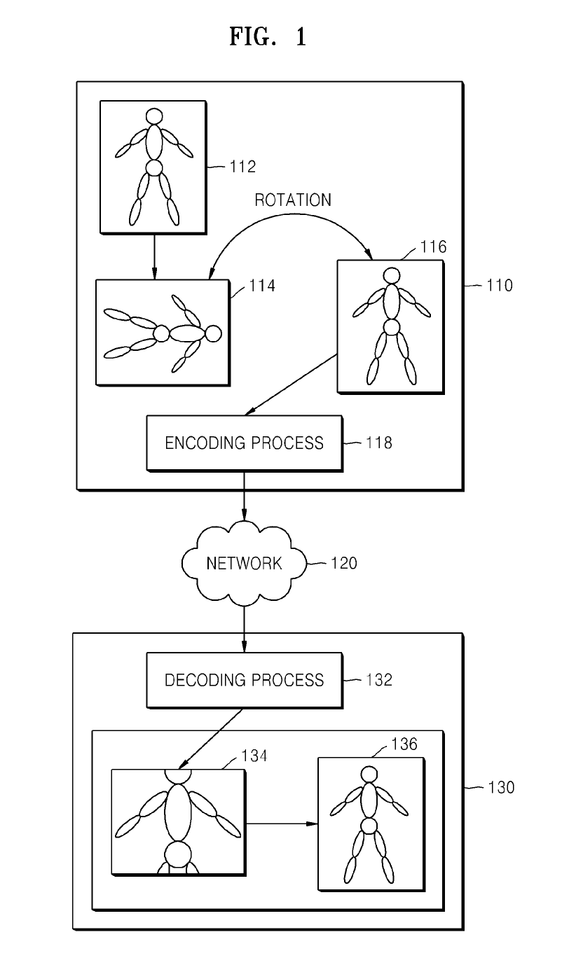

FIG. 1 is a conceptual diagram illustrating the communication of camera image between a camera video processing apparatus 110 and a camera video reproducing apparatus 130 according to an exemplary embodiment.

Herein, a mobile device with a camera may be an example of the camera video processing apparatus 110 and a TV or a PC may be an example of the camera video reproducing apparatus 130, to which the exemplary embodiment is not limited.

Referring to FIG. 1, the camera video processing apparatus 110 stores a vertically-captured image 112, i.e., the vertical image 112, horizontally as an image 114 with a predetermined aspect ratio (i.e., a predetermined horizontal-to-vertical ratio), rotates the image 114 with the predetermined aspect ratio by a predetermined angle (e.g., 90°), and encodes (118) the rotated image 116 together with additional information to format the same into a bitstream.

Thereafter, the camera video processing apparatus 110 transmits the bitstream through a network 120 to the camera video reproducing apparatus 130.

The camera video reproducing apparatus 130 decodes (132) the bitstream, received through the network 120, to extract an image 134.

In this case, if a vertical image is displayed on a horizontally wide screen, the vertical image may be cut due to an aspect ratio mismatch. Thus, the camera video reproducing apparatus 130 has to rescale the height of the vertical image according to the height of the horizontally wide screen.

Thus, the camera video reproducing apparatus 130 rescales the vertical size of a decoded image according to the height of a screen and displays the rescaled image 136 on the screen.

According to the exemplary embodiment, regardless of whether an image is captured horizontally or vertically by a camera in the camera video processing apparatus, the camera video reproducing apparatus can display the captured image on the screen without the need to rotate the captured image.

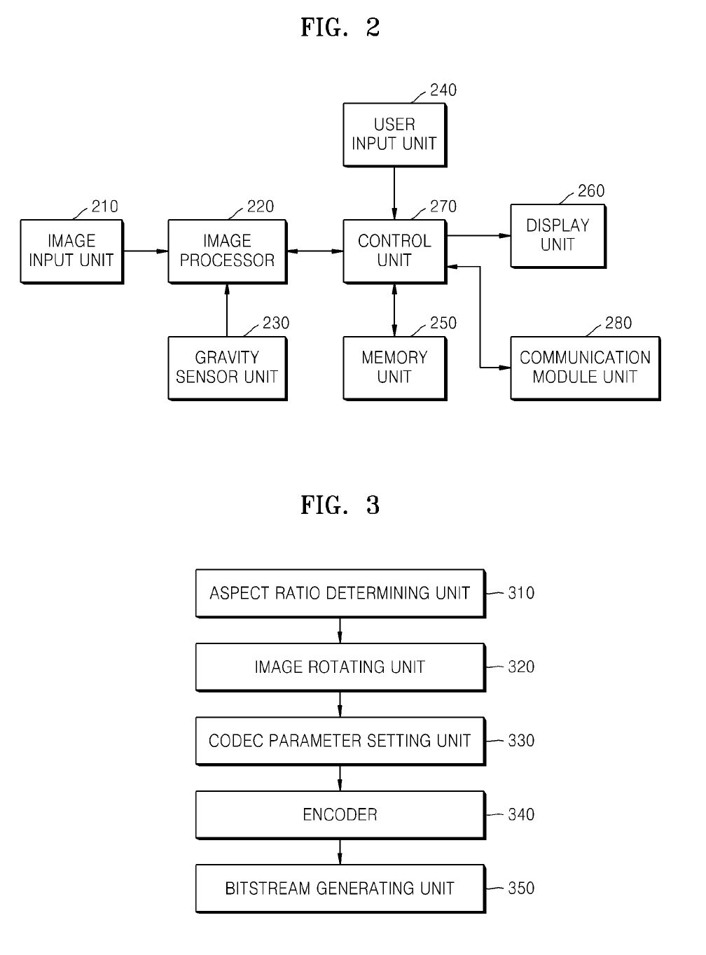

FIG. 2 is a block diagram of the camera video processing apparatus 110 according to an exemplary embodiment.

Referring to FIG. 2, the camera video processing apparatus 110 includes an image input unit 210, an image processor 220, a gravity sensor unit 230, a user input unit 240, a memory unit 250, a display unit 260, a control unit 270, and a communication module unit 280.

The image input unit 210 is configured to input a moving image (video) or a still image captured by a camera. The image input unit 210 includes an image sensor for converting light, input through a lens, into an electrical signal to output an image signal.

The gravity sensor unit 230 senses the direction of the gravity with respect to the camera to output gravity direction information of the camera. That is, the gravity sensor unit 230 senses a photographing orientation, i.e., whether a photograph is being taken horizontally or vertically.

On the basis of the gravity direction information outputted from the gravity sensor unit 230, the image processor 220 determines an aspect ratio of the image signal input by the image input unit 210. The image processor 220 rotates the horizontal or vertical image according to the display orientation of a preview screen of the camera according to the determination result, sets the rotation information of the horizontal or vertical image in a codec parameter, and encodes the codec parameter and the video.

The user input unit 240 uses a plurality of buttons to input user control commands related to image processing. Examples of the user input unit 240 include a control input device (e.g., a keyboard or a mouse), buttons, direction keys, or a combination thereof, to which the exemplary embodiment is not limited.

The control unit 270 controls each unit, outputs the image signal input from the image processor 220 to the display unit 260, and transfers the control command received through the user input unit 240 to the image processor 220 while displaying the received control command in graphic character on the display unit 260.

For example, the control unit 270 includes a microprocessing unit (MPU) or an integrated circuit (IC) with a plurality of circuits for implementing a control function.

The memory unit 250 stores a plurality images processed by the image processor 220, or stores data necessary for a control operation of the control unit 270. Examples of the memory unit 250 include a magnetic recording medium (e.g., a hard disk) and a nonvolatile memory (e.g., an EEPROM or a flash memory), to which the exemplary embodiment is not limited.

The display unit 260 displays the image signals processed by the image processor 220 under the control of the control unit 270.

The display unit 260 may include a liquid crystal display (LCD), to which the exemplary embodiment is not limited.

The communication module unit 280 communicates with the camera video reproducing apparatus 130 in a wired/wireless manner under the control of the control unit 270.

Thus, according to the present exemplary embodiment, the camera video processing apparatus 110 correctly rotates the vertically captured image prior to encoding and thus the camera video reproducing apparatus 130 can display the horizontally captured image and the vertically-captured image without any difficulty.

FIG. 3 is a block diagram of the image processor 220 of FIG. 2.

Referring to FIG. 3, the image processor 220 includes an aspect ratio determining unit 310, an image rotating unit 320, a codec parameter setting unit 330, an encoder 340, and a bitstream generating unit 350.

On the basis of the gravity direction information output from the gravity sensor unit 230, the aspect ratio determining unit 310 determines an aspect ratio (i.e., a horizontal-to-vertical ratio) of the captured image.

According to the image aspect ratio determined by the aspect ratio determining unit 310, the image rotating unit 320 rotates the horizontal or vertical image according to the display orientation of a preview screen of the camera so that the horizontal or the vertical image is properly displayed in its proper vertical or horizontal orientation. At this point, the image rotating unit 320 may rotate the image by 90° at a high speed. For example, the image rotating unit 320 may use a bitmap or hardware to rotate the image. For example, if the image has an aspect ratio of x:y, the image rotated by the image rotating unit 320 has a changed aspect ratio of y:x.

The codec parameter setting unit 330 adds the rotation information of the horizontal/vertical image, received from the image rotating unit 320, in a codec parameter of a predetermined file format.

The encoder 340 uses a predetermined encoding algorithm to encode the codec parameter and the image.

The bitstream generating unit 350 formats the encoded codec parameter and image data of the encoder 340 into a bitstream of a predetermined standard such as H.264.

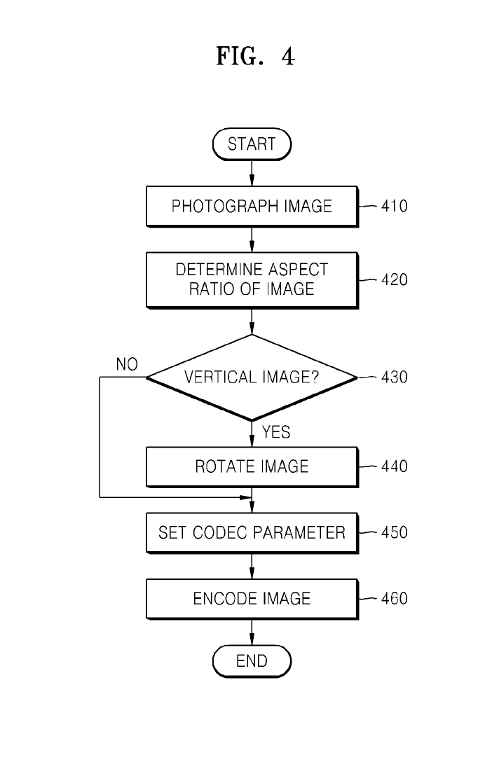

FIG. 4 is a flowchart illustrating a camera video processing method according to an exemplary embodiment.

Referring to FIG. 4, a moving image (video) or a still image is captured by the camera (operation 410).

Here, a gravity sensor is used to sense whether the image was captured horizontally or vertically.

In operation 420, the gravity sensor information is used to determine an aspect ratio of the captured moving/still image (operation 420).

Thereafter, it is determined whether the moving/still image is a vertical image (operation 430).

Thereafter, if the moving/still image is a vertical image, the moving/still image is rotated by a predetermined angle, for example, by 90° (operation 440).

That is, the vertical image, or even a horizontal image, is rotated according to the display orientation of a preview screen of the camera (or to the viewing direction of a person) according to the image aspect ratio.

At this point, the image moving/still image is rotated by 90° at a high speed. For example, a bitmap or hardware is used to rotate the moving/still image.

Thereafter, the moving/still image is rotated correctly according to the photographing orientation and then information about the horizontal pixels and vertical pixels of the moving/still image is corrected.

That is, the pixel values of the vertical image for the moving/still image are set according to the direction of the gravity.

Thus, the horizontal or vertical information according to the image rotation, i.e., the image rotation information, is added in a codec parameter (operation 450).

For example, the updated image rotation information is added to a Sequence Parameters Set (SPS) in a video file format H.264.

Thereafter, a predetermined encoding algorithm is used to encode the codec parameter and the image (operation 460).

Finally, the encoded codec parameter and image data are formatted into a bitstream of a predetermined standard such as H.264.

Thus, according to the present exemplary embodiment, the image is automatically rotated according to the direction of the gravity with respect to the camera prior to encoding, thus enabling the camera video reproducing apparatus 130 to display the horizontally-captured image and the vertically-captured image without any difficulty even without correcting the video format.

Also, according to the present exemplary embodiment, the device is compatible with other devices by the pre-processing of the exemplary embodiment and there is no need to install a post-processing module for detecting the format in the decoder.

Furthermore, according to the present exemplary embodiment, there is no need to add any additional information to a general video format.

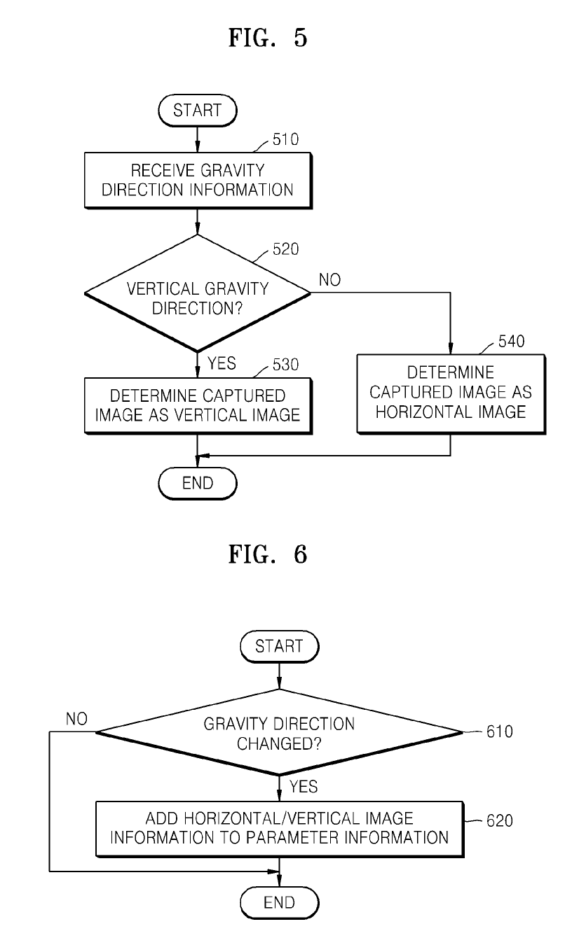

FIG. 5 is a flowchart illustrating the image aspect ratio determining operation 420 of FIG. 4, according to an exemplary embodiment.

Referring to FIG. 4, camera gravity direction information generated by the gravity sensor in a photographing operation is received (operation 510).

Thereafter, it is determined whether the camera gravity direction is a vertical direction (operation 520).

Thereafter, if the camera gravity direction is a vertical direction, the currently captured image is determined to be a vertical image (operation 530); otherwise, if the camera gravity direction is a horizontal direction, the currently captured image is determined to be a horizontal image (operation 540).

FIG. 6 is a flowchart illustrating the code parameter setting operation 450 of FIG. 4, according to an exemplary embodiment.

Referring to FIG. 6, it is determined whether the camera gravity direction changes during a video photographing operation (operation 610).

Thereafter, whenever the camera gravity direction for video photographing changes, the horizontal or vertical image information is added to codec parameter information (operation 620). For example, the codec parameter information includes the size or ratio of the horizontal or vertical image at the time when the camera gravity direction changes during the video photographing operation.

Consequently, whenever the camera gravity information changes in a video photographing operation, the codec parameter information including the updated size and ratio of the horizontal or vertical image is added to the file format.

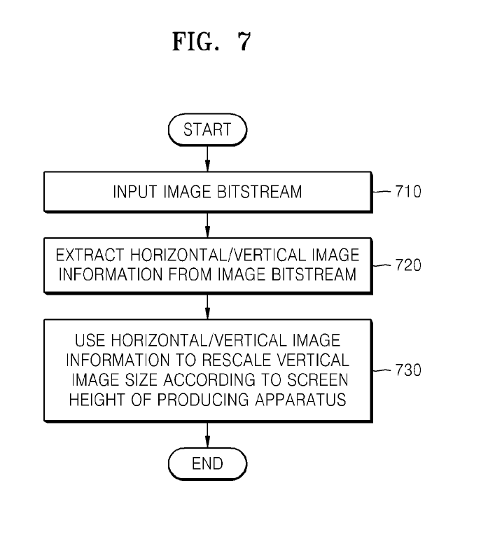

FIG. 7 is a flowchart illustrating a camera video reproducing method according to an exemplary embodiment.

Referring to FIG. 7, an image bitstream of a predetermined video file format such as H.264 is received (operation 710). Herein, the image bitstream includes image data and parameter information.

Thereafter, image data and parameter information are extracted from the image bitstream and horizontal or vertical image (video width and video height) information is extracted from the parameter information (operation 720).

Thereafter, the horizontal or vertical image information is used to rescale the vertical size of an image according to the height of a display screen (operation 730).

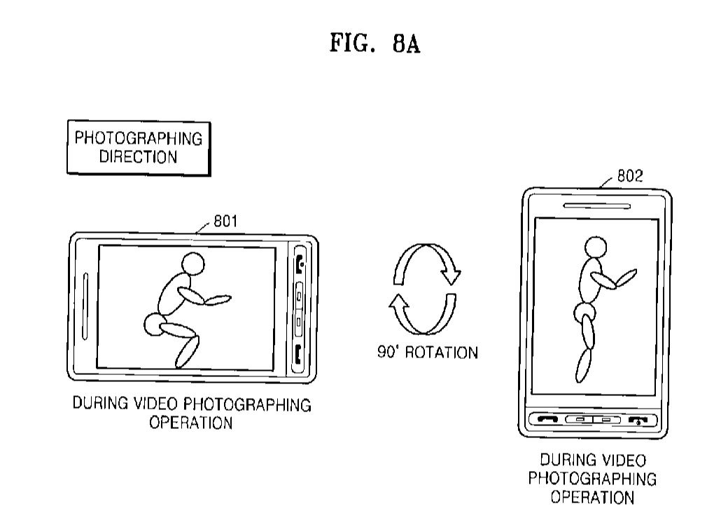

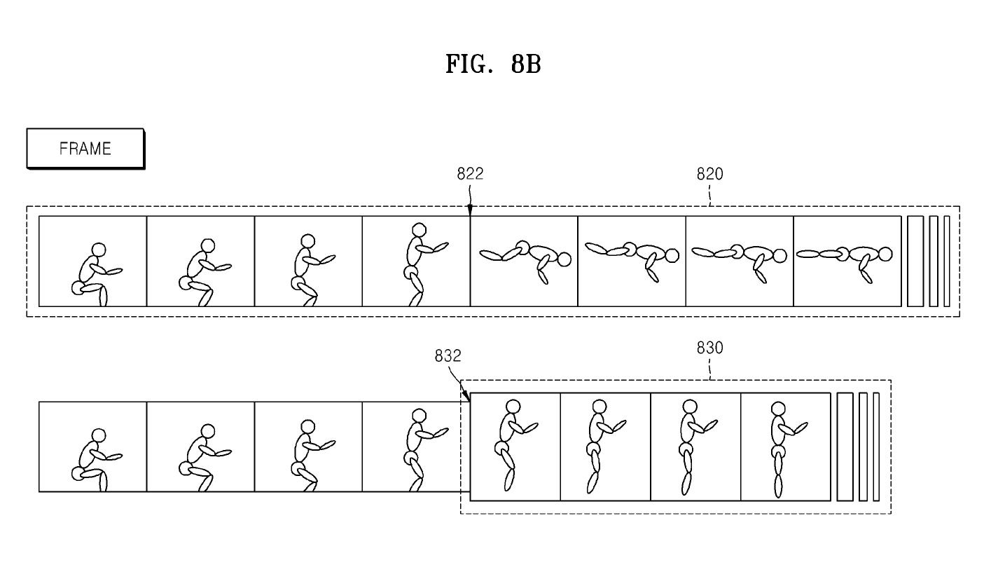

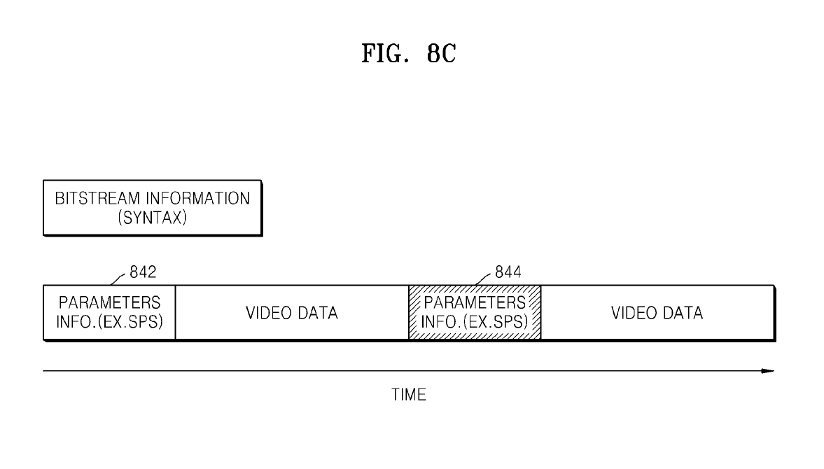

FIGS. 8A to 8C are conceptual diagrams illustrating the construction of a bitstream in a video photographing operation, according to exemplary embodiments.

Referring to FIG. 8A, if an image is captured in a horizontal direction (801) during a video photographing operation, the image is rotated by 90° and the rotated image is displayed in a vertical direction (802) on a preview screen of the camera.

Referring to FIG. 8B, an embodiment 820 of a conventional technique stores a horizontal image frame in a memory even when the photographing orientation of a camera changes from horizontal to vertical. In other words, the conventional technique stores an image frame of a fixed aspect ratio even when a gravity sensor detects (822) a change in the photographing orientation.

However, an exemplary embodiment 830 automatically rotates an image by 90° when the gravity sensor detects (832) a vertical image frame. In other words, when an aspect ratio of the video changes during the video photographing operation, the gravity sensor detects the aspect ratio change. The image frame is automatically rotated by 90° at the time when the vertical image is detected.

FIG. 8C illustrates the syntax of a video bitstream according to time.

The video stream includes video-related parameter information and video data.

Referring to FIG. 8C, parameter information 842 is set at a start portion of a video bitstream in a video photographing operation. When an aspect ratio of the video changes during the video photographing operation, new parameter information 844 including the changed video aspect ratio information may be added to a center portion of the video bitstream.

Thus, whenever the photographing orientation of the camera changes during a video photographing operation, the updated video aspect ratio information may be added to the parameter information.

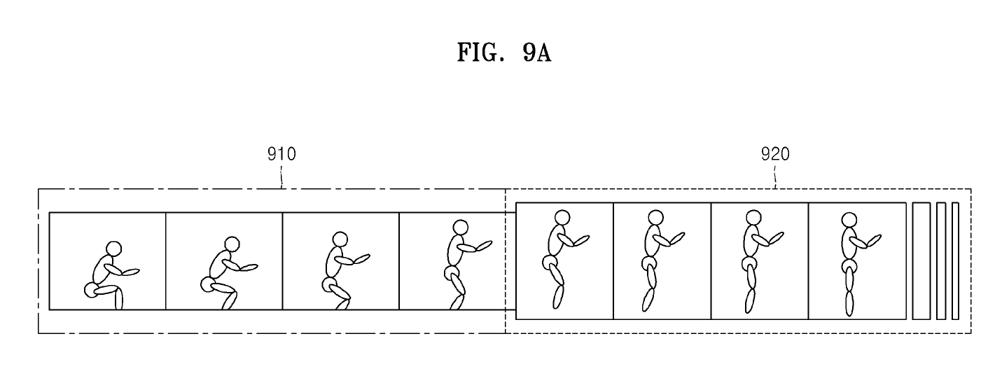

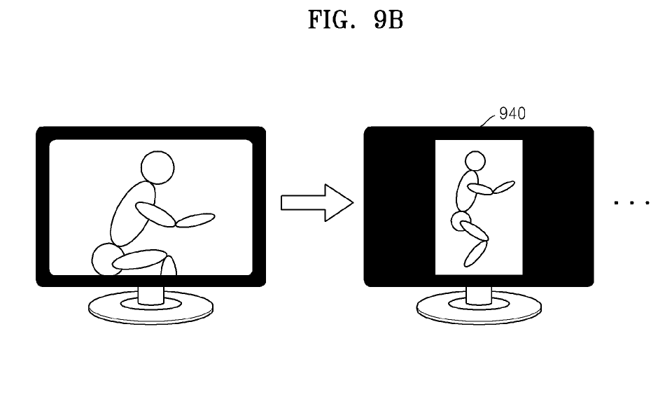

FIGS. 9A and 9B illustrate a rendering method of a camera video reproducing apparatus, according to exemplary embodiments.

If a vertical image is displayed on a horizontally wide screen, the vertical image may be cut due to an aspect ratio mismatch in order to adapt the vertical image to the horizontally wide screen.

Thus, as illustrated in FIG. 9A, in the event of a change from horizontal image mode to vertical image mode, the camera video reproducing apparatus performs a high-speed recalling operation 920 according to an aspect ratio so that the image is not cut when a vertical image 910 is rendered on a horizontally wide screen, as shown in FIG. 9B.

Referring to FIG. 9B, in the event of a change from a horizontal image mode to a vertical image mode, the vertical image, i.e., the image 940, is obtained by vertically rescaling the vertical image so the vertical image is disposed in a center region of a screen, and the remaining empty region is filled with a black background.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard disks, floppy disks, flash memories, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A camera video processing method comprising:
determining an aspect ratio of a captured image;
rotating the captured image according to a display orientation of a preview screen of an image capture device according to the determined aspect ratio, to output a rotated image and rotation information;
setting the rotation information of the captured image in a codec parameter; and
encoding the codec parameter and the rotated image.

2. The camera video processing method of claim 1, wherein the determining of the aspect ratio comprises detecting camera gravity direction information by a gravity sensor and determining the aspect ratio basis on the detected camera gravity direction information.

3. The camera video processing method of claim 1, wherein the rotating of the captured image comprises rotating one of a moving image and a still image by a predetermined angle if the one of a moving image and a still image is a vertical image.

4. The camera video processing method of claim 1, wherein the setting of the codec parameter comprises setting updated horizontal image information or vertical image information to codec parameter information when the camera gravity direction changes during a video photographing operation.

5. The camera video processing method of claim 4, wherein the codec parameter information comprises a size and a ratio of the captured image at a time when the camera gravity direction changes during the video photographing operation.

6. The camera video processing method of claim 4, wherein the codec parameter information is added when the camera gravity direction information changes during the video photographing operation.

7. The camera video processing method of claim 1, wherein the setting of the codec parameter comprises correcting information related to a pixel of a horizontal image or a vertical image of a moving image or a still image.

8. The camera video processing method of claim 1, further comprising formatting the encoded codec parameter and image data into a bitstream of a predetermined standard.

9. A camera video reproducing method comprising:
receiving a camera image bitstream;
extracting image data and codec parameter information from the camera image bitstream;
extracting horizontal image information or vertical image information from the codec parameter information; and
rescaling a size of a vertical image according to a height of a display screen based on the horizontal or the vertical image information.

10. A camera video processing apparatus comprising:
an aspect ratio determining unit which determines an aspect ratio of a captured image by using gravity sensor information;
an image rotating unit which rotates a horizontal image or a vertical image according to a display orientation of a preview screen of an image capture device according to a determination result of the aspect ratio determining unit, to output a rotated image and rotation information;
a codec parameter setting unit which adds the rotation information of the rotated image, received from the image rotating unit, in a codec parameter; and
an encoder which encodes the rotated image and the codec parameter of the codec parameter setting unit.

11. The camera video processing apparatus of claim 10, further comprising a gravity sensor which senses horizontal/vertical gravity to determine the aspect ratio of the captured image.

12. The camera video processing apparatus of claim 10, wherein the codec parameter setting unit includes pixel information of an image updated whenever a photographing orientation of the camera changes.

13. A computer readable recording medium storing a program for executing the method of processing camera video, the method comprising:
determining an aspect ratio of a captured image;
rotating the captured image according to a display orientation of a preview screen of an image capture device according to the determined aspect ratio, to output a rotated image and rotation information;
setting the rotation information of the captured image in a codec parameter; and
encoding the codec parameter and the rotated image.

14. A computer readable recording medium storing a program for executing the method of reproducing camera video, the method comprising:
receiving a camera image bitstream;
extracting image data and codec parameter information from the camera image bitstream;
extracting horizontal image information or vertical image information from the codec parameter information; and
rescaling a size of a vertical image according to a height of a display screen based on the horizontal or the vertical image information.
